(19) United States
(12) Patent Application Publication
(10) Pub. No.: US 2018/0247184 A1
(43) Pub. Date: Aug. 30, 2018

(54) IMAGE PROCESSING SYSTEM

(71) Applicant: IDEMIA IDENTITY & SECURITY France, ISSY LES MOULINEAUX (FR)

(72) Inventors: Sarah LANNES, ISSY LES MOULINEAUX (FR); Vincent DESPIEGEL, ISSY LES MOULINEAUX (FR)

(21) Appl. No.: 15/899,041

(22) Filed: Feb. 19, 2018

(30) Foreign Application Priority Data
Feb. 27, 2017 (FR) 1751562

(51) Int. Cl. G06N 3/04; G06K 9/62; G06K 9/66; H04N 1/40; G06N 3/08

(52) U.S. Cl. CPC G06N 3/0454; G06K 9/6256; G06N 3/08; H04N 1/40062; G06K 9/66

(57) ABSTRACT

Image processing system (I₁, . . . Iₙ), including a main neural network (2) and, upstream thereof, a preprocessing module (3) including several neural networks (R₁, . . . , Rₙ) working in parallel to process several starting images of the same object and configured to generate, by fusing the outputs of these networks, a representation (D) of the object improving the performance of the main neural network, the learning of the neural networks of the preprocessing module (3) being performed at least partly simultaneously with the one of the main neural network (2).

The present invention relates to systems for processing images using neural networks, and more particularly but not exclusively to those intended for biometrics, in particular for the recognition of faces.

The invention is more particularly applicable to processing systems using, as starting information, several images of one and the same subject, for example from different viewing angles at the same time or at different times, these images being for example extracted from a video stream, in particular from surveillance video, or from a collection of images, for example of one and the same individual at different ages.

It is known practice to generate, on the basis of a plurality of starting images in a certain resolution, images in a higher resolution, by means of a technique referred to as the “super-resolution” technique.

The article “Super-resolution from multiple views using learnt image models” by David Capel et al, Department of Engineering Science, University of Oxford, thus describes examples of generating higher resolution images of faces using learned image models.

The article “Feature-domain super-resolution framework for Gabor-based face and iris recognition” by K Nguyen et al, Image and Video Research Lab, Queensland University of Technology, describes the use of super-resolution to improve the performance of biometric systems.

The article “Video Super-Resolution Using Classification ANN” by Ming-Hui Cheng et al. International Scholarly and Scientific Research & Innovation 7(7), 2013, describes the use of neural networks to produce images having enhanced resolution.

The article by Junyu Wu et al, “Deep joint face hallucination and recognition”, Cornell University Library, Nov. 24, 2016, discloses a facial recognition system using a deep neural network comprising a sub-network to obtain super-resolved images, in series with a sub-network for recognition. Gradient calculations are used to optimize the parameters of the two networks jointly.

The article by Xin Yu et al, “Face hallucination with tiny unaligned images by transformative discriminative neural networks”, Feb. 4, 2017, describes a transformative discriminative neural network for obtaining super-resolution representations of tiny or unaligned images of faces, comprising an oversampling network and a discriminative network.

The article by Alex Greaves et al, “Multi-frame video super-resolution using convolutional neural networks”, Mar. 23, 2016, pages 1-9, teaches the use of a neural network to obtain a high-resolution version of a frame in a video by taking into account pixel information from adjacent frames.

The article by Frederick Wheeler et al, “Multi-frame super-resolution for face recognition”, IEEE International conference on biometrics: theory, applications, and systems, 2007, pages 1-6, describes a method for combining frames of a video sequence to obtain a super-resolved image for improved facial recognition. A model of face shape is used for learning and is subsequently applied to the face in each frame, several frames being combined by calculating a cost function to obtain the super-resolved image.

The article by Chen Jun-Cheng et al, “Unconstrained face verification using deep CNN features”, IEEE Winter conference on applications of computer vision, 2016, pages 1-9, discloses an unconstrained face verification algorithm using features learned and extracted by a single deep convolutional neural network. When several images of a video are available as input for one and the same subject, an average of the extracted features is used.

There is a need to improve the biometric chains based on neural networks still further, in particular to enhance their performance for recognition on the basis of a video stream or a collection of images.

The invention meets this need by virtue, according to one of its aspects, of an image processing system, including a main neural network and, upstream thereof, a preprocessing module including several neural networks working in parallel to process several starting images of the same object, in particular a face, and configured to generate, by fusing the outputs of these networks, a representation of the object improving the performance of the main neural network, the learning of the neural networks of the preprocessing module being performed at least partly simultaneously with the one of the main neural network.

Training the preprocessing module with the main neural network makes it possible to have a correction that is perfectly suited to the needs of the analysis of the descriptors as determined by the trained main neural network.

The performance of the image processing system is improved while making it possible, unlike in known solutions based on an enrichment of the learning data, to retain the capacity of the deep layers of the main network for learning descriptors, by avoiding dedicating this capacity to compensating for image quality problems linked to their low resolution for example. A more powerful conventional network would allow the same level of performance to be reached, but would be slower and more expensive, and would use more RAM.

The starting images may vary. They may be for example images extracted from a video stream of one and the same object, for example from a video surveillance system.

They may also be images extracted from a collection of images taken independently of one and the same object, for example several photographs taken at the same time but from different viewing angles.

They may also be a collection of photographs of an individual at different ages, or even a collection of photographs and/or sketches of one and the same individual, among other possibilities.

The preprocessing performed by said networks of the preprocessing module preferably includes an image registration operation, in particular a 3D image registration operation. In particular, the preprocessing module may include layers of preprocessing networks that are configured to transform the starting images into frontal images. Specifically, the best biometric recognition performance is generally obtained for frontal images of individuals.

Preferably, the representation of the object includes at least one set of parameters describing the shape of the object, in particular, in the case of a face, parameters shape, expression and texture.

The representation of the object may include an image of the object.

Preferably, the resolution of the representation of the object is higher, in particular for at least a portion of the object, than that of the starting images. A super-resolution technique is thus used.

The preprocessing module may include at least one first stage of preprocessing by layers of neural networks making it possible to learn, with exchanges of information between the networks, at least one parameter linked to the object, and at least one second stage of preprocessing by layers of neural networks receiving, as input, a corresponding starting image or a transformation of the latter and at least said parameter.

The preprocessing module may be configured to generate, by processing the starting images, transformed data with a confidence map for these data.

The preprocessing module may include preprocessing networks generating output images and associated confidence maps, and a network for fusing the output images on the basis of these images and confidence maps.

The main network may be a classification network.

The processing carried out by the preprocessing module advantageously takes into account, in its learning, geometric particularities of the object, in particular a certain symmetry, in particular in the case of a face.

The neural networks of the preprocessing module may be convolutional networks, also referred to as CNNs.

Another subject of the invention, according to another of its aspects, is a learning method for a system according to the invention, such as defined above, wherein at least a portion of the learning of the neural networks of the preprocessing module is performed simultaneously to the one of the main network.

Another subject of the invention, according to another of its aspects, is an image processing method, wherein the images are processed by a system according to the invention, such as defined above.

Another subject of the invention, according to another of its aspects, is a method for classifying objects, in particular faces, wherein, using a system according to the invention, descriptors are generated for the objects allowing them to be classified, in particular for the purpose of recognizing a face.

The invention will be better understood upon reading the following description of exemplary nonlimiting modes of implementation of the invention and upon examining the appended drawing, in which:

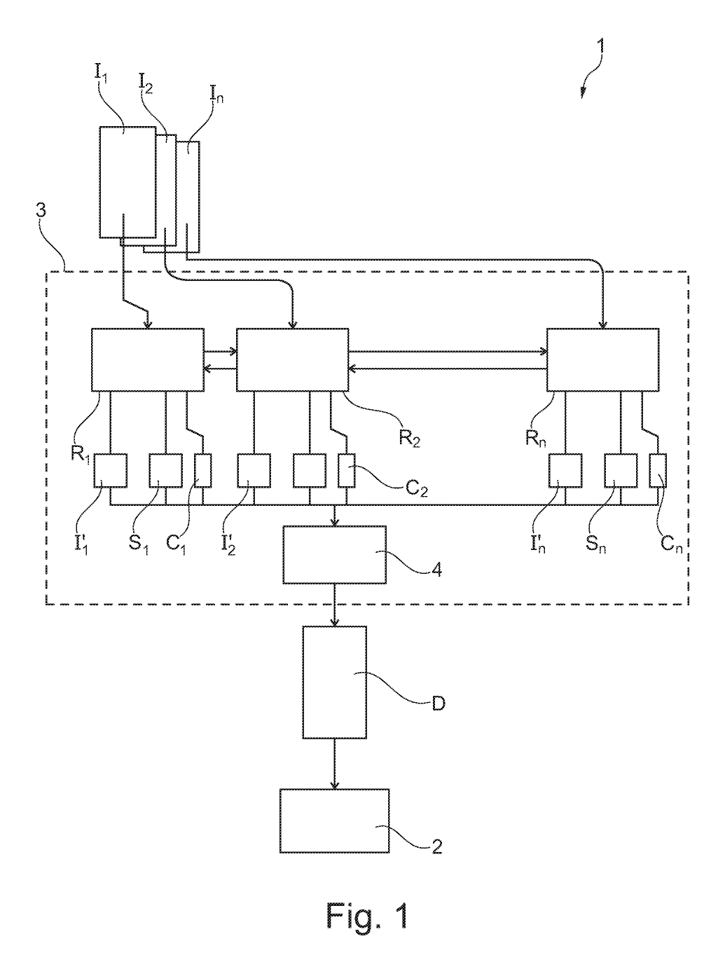

FIG. 1 is a block diagram of an exemplary processing system according to the invention.

FIG. 1 shows an exemplary image processing system 1 according to the invention.

This system 1 includes, in the example under consideration, a main neural network 2, which is for example a classification network, and a preprocessing module 3 upstream thereof. The neural network 2 may be of any type, preferably being a convolutional neural network. One example of such a CNN is described under the reference “LeNet” by Yann LeCun on the site http://yann.lecun.com/exdb/lenet/The module 3 includes several neural networks R₁, . . . , Rₙ, for example convolutional neural networks, working in parallel to process several starting images I₁, . . . Iₙ of one and the same object, preferably a face.

The module 3 is configured to generate, by fusing the outputs of the networks R₁, . . . , Rₙ, a representation D of the object improving the performance of the main neural network 2.

The representation D of the object includes at least one set of parameters S describing the shape of the object, in particular, in the case of a face, shape, expression and texture parameters S, and/or an image I_{SR} of the object, the resolution of which is higher than that of the starting images, in particular for at least a portion of the object. The publication by Blanz V, Vetter T., “A morphable model for the synthesis of 3d faces”. Proceedings of SIGGRAPH. 1999:187-194 describes examples of such parameters.

The starting images I₁, . . . Iₙ may vary. They may be for example images of faces extracted from a video stream, for example from a video surveillance system. They may also be images of faces extracted from a collection of images taken independently, for example several photographs taken at the same time but from different viewing angles. They may also be a collection of photographs of an individual at different ages, or even a collection of photographs and/or sketches of one and the same individual, among other possibilities.

The preprocessing carried out by the preprocessing module 3 preferably includes a 3D registration of the images for the purpose of transforming the starting images into frontal images.

The preprocessing networks R₁, . . . , Rₙ may thus generate registered output images I_{S1}, . . . I_{Sn} and/or sets of associated shape parameters S, as well as confidence weighting maps C₁, . . . Cₙ that are linked for example to the local confidence in this registration.

The registration may be carried out as described for example in the publication “Spatial Transformer Networks”, Max Jadeberg, K Simonyan, A Zisserman, K Kavukcuoglu, NIPS 2015 for example.

The shape parameters may be extracted as described in the publication “Estimating 3D Shape and Texture Using Pixel Intensity, Edges, Specular Highlights, Texture Constraints and a Prior”. CVPR (2) 2005: 986-993 for example.

The module 3 may include, as illustrated, a network 4 for fusing the output images I′₁, . . . I′ₙ and/or parameter maps S₁, . . . Sₙ on the basis of the confidence maps C₁, . . . Cₙ to generate the representation D of the object used by the main network 2 downstream. The fusion network 4 may be configured to take a weighted sum, among other possibilities.

The processing carried out by the preprocessing module 3 advantageously takes into account, in its learning, geometric particularities of the object, in particular the symmetry that is found on a face and/or the approximate position of the eyes.

According to the invention, the neural networks of the preprocessing module 3 learn, at least partly, simultaneously with the main neural network 2. Since the transformations carried out by the preprocessing module 3 can be differentiated, they do not hinder the backpropagation process required for the learning of these networks.

Preferably, the learning for the registration of the images I₁, . . . Iₙ by the networks R₁, . . . , Rₙ is performed in a first instance using a 3D model of the object, without the simultaneous learning of the main network 2. Starting images of one and the same object from several viewing angles, generated by computer, are used for example. Next, once registration learning has started, the simultaneous learning of the module 3 and of the main network 2 is performed, so as to refine the registration and the operation of fusing the parameter maps S₁, . . . Sₙ and/or the output images I′₁, . . . I′ₙ. Proceeding in such a manner may decrease the risk of instability in registration learning.

Training the preprocessing module 3 with the main neural network 2 makes it possible to have a correction that is perfectly suited to the needs of the analysis of the descriptors as determined by the main neural network 2.

Simultaneous learning makes it possible to optimize the registration and the representation of the object to increase the accuracy of the registration and the gain in resolution for example, with respect to those parameters and areas which matter most for the biometric performance of the main network 2. Thus, certain zones could be registered more precisely than others.

The invention is not limited to image classification applications and is also applicable to identification and to authentication in facial biometrics.

The processing system according to the invention may also be applied to detection, to biometrics other than that of the face, for example that of the iris.

The invention may be implemented on any type of hardware, for example a personal computer, a smartphone, a dedicated board, or a supercomputer.

1. Image processing system, including a main neural network and, upstream thereof, a preprocessing module including several neural networks working in parallel to process several starting images of the same object and configured to generate, by fusing the outputs of these networks, a representation of the object improving the performance of the main neural network, the learning of the neural networks of the preprocessing module being performed at least partly simultaneously with the one of the main neural network.

2. System according to claim 1, wherein the starting images are extracted from a video stream or extracted from a collection of images.

3. System according to claim 1, wherein the object is a face.

4. System according to claim 1, wherein the preprocessing performed by said networks of the preprocessing module includes an image registration operation, in particular a 3D image registration operation.

5. System according to claim 1, the preprocessing module includes layers of preprocessing networks that are configured to transform the starting images into frontal images.

6. System according to claim 1, the representation of the object includes at least one set of parameters describing the shape of the object, in particular, in the case of a face, parameters of shape, expression and texture.

7. System according to claim 1, wherein the representation of the object includes an image of the object.

8. System according to claim 1, wherein the resolution of the representation of the object is higher, in particular for at least a portion of the object, than that of the starting images.

9. System according to claim 1, wherein the preprocessing module includes at least one first stage of preprocessing by layers of neural networks making it possible to learn, with exchanges of information between the networks, at least one parameter linked to the object, and at least one second stage of preprocessing by layers of neural networks receiving, as input, a corresponding starting image or a transformation of the latter and at least said parameter.

10. System according to claim 1, wherein the preprocessing module is configured to generate, by processing the starting images, transformed data with a confidence map for these data.

11. System according to claim 10, wherein the preprocessing module includes preprocessing networks generating output images and associated confidence maps, and a network for fusing the output images on the basis of these images and confidence maps.

12. System according to claim 1, wherein the main network is a classification network.

13. System according to claim 1, wherein the processing carried out by the preprocessing module takes into account, in its learning, geometric particularities of the object, in particular a certain symmetry.

14. System according to claim 1, wherein the neural networks of the preprocessing module are convolutional networks.

15. Learning method for a system according to claim 1, wherein at least a portion of the learning of the neural networks of the preprocessing module is performed simultaneously to the one of the main network.

16. Method according to claim 15, wherein the processed images are extracted from a video stream or from a collection of images.

17. Method for classifying objects, in particular faces, wherein, using a system according to claim 1, descriptors are generated for the objects allowing them to be classified, in particular for the purpose of recognizing a face.
